(19) United States
(12) Patent Application Publication
(10) Pub. No.: US 2026/0310394 A1
(43) Pub. Date: Oct. 8, 2026

(54) METHOD FOR PROCESSING VIDEO FRAMES WITH REDUCED APPLICATION PROCESSOR SYSTEM INVOLVEMENT

(71) Applicant: QUALCOMM Incorporated, San Diego, CA (US)

(72) Inventors: Sreekanth MODAIKKAL, Bangalore (IN); Kalyan THOTA, Hyderabad (IN); Abhijit Kumar GUPTA, Bangalore (IN); Jaya Prakash MADISETTY, Hyderabad (IN)

(21) Appl. No.: 19/173,137

(22) Filed: Apr. 8, 2025

(51) Int. Cl. G06F 3/14

(52) U.S. Cl. CPC G06F 3/14

(57) ABSTRACT

Disclosed are techniques for processing video frames with reduced application processor system involvement. In an aspect, a method for processing video frames includes, at a display subsystem for processing and displaying video frame data that has been stored in a plurality of video frame buffers in a memory, receiving a plurality of triggers to process a video frame, and, in response to receiving each of the plurality of triggers, processing the video frame without involvement of an application processor, wherein a first trigger of the plurality of triggers is a software trigger generated by an application processor and subsequent triggers of the plurality of triggers are hardware triggers that are generated by the display subsystem itself without involvement of an application processor.

### BACKGROUND OF THE DISCLOSURE

### 1. Field of the Disclosure

Aspects of the disclosure relate generally to processing and displaying video frames.

### 2. Description of the Related Art

Video is conventionally encoded into a sequence of video frames, each video frame having a static image. Video playback involves displaying the sequence of static images rapidly enough to give the viewer the impression of motion, with typical rates being thirty frames per second (fps), sixty fps, etc. Typically, each video frame is processed prior to being sent to a video monitor, computer screen, or other display device. For example, video data may be compressed or otherwise encoded for storage and therefore must be decompressed and/or decoded prior to playback; the video frame data may need to be reformatted to fit the display size, resolution, color depth, etc.; the video frame data may be combined with other video data by a compositor; and so on. The processed video frame data is then sent to the display device. A display device may include two display buffers: while the first display buffer drives the display, the second display buffer is being loaded with the next frame to be displayed; while the second display buffer drives the display, the first display buffer is being loaded with the next frame to be displayed.

In a common hardware implementation, a video subsystem, which may also be referred to as a video core, prepares video frames and stores each frame in a separate video frame buffer (different from the display buffers) which is a block of random access memory (RAM) that is reserved for that purpose. Typically, there are a limited number of video frame buffers, which are used in a round-robin fashion. When the video subsystem finishes writing the decoded video frame into the video frame buffer, it notifies a display subsystem, which may also be referred to as a display processing unit (DPU). The display subsystem reads the video frame from the video frame buffer and processes it as needed prior to being sent to the display device. Once the display subsystem finishes with the video frame, it notifies the video subsystem that the buffer is available for reuse.

Notably, every video frame may have its own set of video frame characteristics, including geometry, color depth, resolution, etc., and the DPU must be properly configured in order to correctly prepare that video frame for display by the display device. In conventional implementations, configuration of the DPU is handled by software, which means that DPU configuration requires involvement by what is referred to as the application processor system (APS) or subsystem (APSS). The APS is activated every time the video subsystem indicates that a completed video frame is available so that the APS can properly configure the DPU before the DPU processes that video frame. Repeatedly waking the APS for this purpose consumes both power and processor resources. A typical implementation uses an interrupt subsystem to wake the APS, which may cause a context switch of one or more processor cores, which consumes even more time, power, and resources.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method for processing video frames with reduced application processor involvement includes at a display subsystem for processing and displaying video frame data that has been stored in a plurality of video frame buffers in a memory: receiving a plurality of triggers to process a video frame; and in response to receiving each of the plurality of triggers, processing the video frame without involvement of an application processor, wherein a first trigger of the plurality of triggers is generated by the application processor and subsequent triggers of the plurality of triggers are generated by the display subsystem.

In an aspect, a semiconductor device includes an application processor subsystem comprising one or more processors for executing application software; an interrupt subsystem for handing interrupts; a video subsystem for preparing video frame data and storing it in a plurality of video frame buffers in a memory; and a display subsystem for processing and displaying video frame data that has been stored in the plurality of video frame buffers, wherein the display subsystem is configured to: receive a plurality of triggers to process a video frame; and in response to receiving each of the plurality of triggers, process the video frame without involvement of the application processor subsystem, wherein a first trigger of the plurality of triggers is generated by the application processor subsystem sent to the display subsystem via the interrupt subsystem, and subsequent triggers of the plurality of triggers are generated internally by the display subsystem.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is an event diagram illustrating a conventional method of processing video frames.

FIG. 2 is a block diagram illustrating a system for processing video frames with reduced application processor system involvement, according to aspects of the disclosure.

FIG. 3 is a block diagram illustrating an example display subsystem in more detail according to aspects of the disclosure.

FIG. 4 is a diagram illustrating the relationship between video frame buffers and command queue FIFOs, according to aspects of the disclosure.

FIGS. 5A and 5B illustrate an embodiment in which a set of configuration commands is reused rather than discarded, according to aspects of the disclosure.

FIG. 6 is a diagram illustrating a method for processing video frames with reduced application processor subsystem (APSS) involvement, according to aspects of the disclosure.

FIG. 7 is a diagram illustrating a method for processing video frames with reduced APSS involvement, according to aspects of the disclosure.

FIG. 8 is a diagram illustrating a method for processing video frames with reduced APSS involvement, according to aspects of the disclosure.

FIG. 9 is a flow chart illustrating a method for processing video frames with reduced APSS involvement, according to aspects of the disclosure.

FIG. 10 is a flow chart illustrating a method for processing video frames with reduced APSS involvement, according to aspects of the disclosure.

FIG. 11 is a block diagram illustrating an example display subsystem in more detail according to other aspects of the disclosure.

FIG. 12 is a diagram illustrating a method for processing video frames with reduced APSS involvement, according to aspects of the disclosure.

FIG. 13 is a flow chart illustrating a method for processing video frames with reduced APSS involvement, according to aspects of the disclosure.

FIG. 14 is a flowchart of an example method for processing video frames with reduced application processor system involvement, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to processing video frames with reduced application processor system involvement. Some aspects relate more specifically to novel hardware configurations that obviate the need to involve application processor cores for configuration of display processing hardware. In an aspect, a method for processing video frames includes, at a display subsystem for processing and displaying video frame data that has been stored in a plurality of video frame buffers in a memory, receiving a plurality of triggers to process a video frame, and, in response to receiving each of the plurality of triggers, processing the video frame without involvement of an application processor, wherein a first trigger of the plurality of triggers is generated by an application processor and subsequent triggers of the plurality of triggers are generated by the display subsystem itself.

Particular aspects of the subject matter described in this disclosure can be implemented to realize one or more of the following potential advantages. The techniques disclosed herein provide a number of new abilities, including: the ability to support skip/repeat video frame requirements in display hardware without requiring software intervention during video playback; the ability to auto-trigger specific command queues within display hardware based on frame buffer identification information provided by video hardware; the ability to pre-load configuration information for multiple video frames – and in some use cases, an unlimited number of video frames – that will be used to configure the display subsystem without action by application processors; and, in some use cases, the ability to support video playback with minimal hardware requirements and no software intervention.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

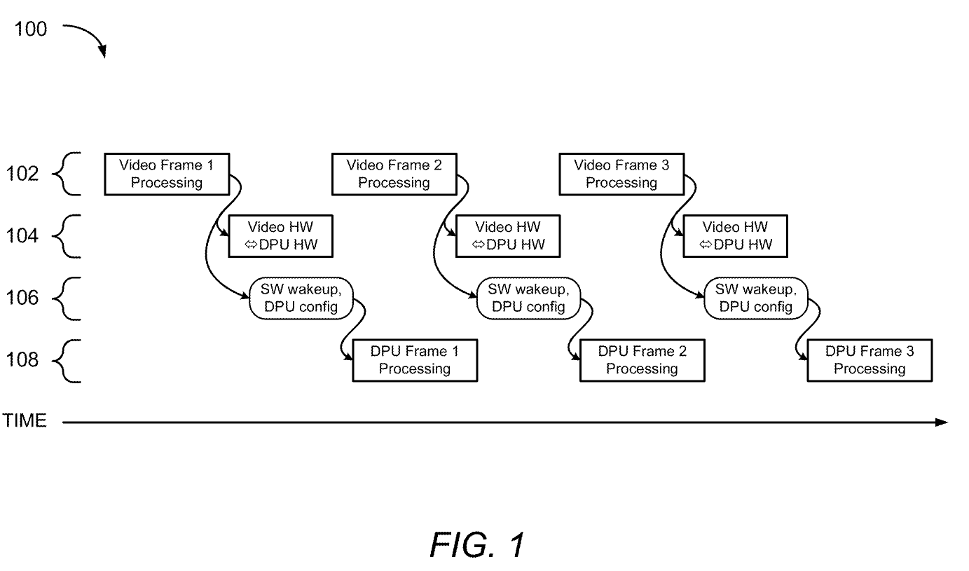

FIG. 1 is an event diagram 100 illustrating a method of processing video frames that includes four pipelined steps: video frame processing 102, transfer of the video frame 104 to the display processing unit (DPU), DPU configuration 106, and DPU frame processing 108. Once a buffer is received at the software compositor, the display library will process the layer and will negotiate with the display driver to accept the composition, which will then be committed to the display hardware.

In such a sample implementation, video frame processing 102 is handled by the video subsystem, transfer of the video frame 104 is done via video frame buffers in RAM memory, DPU configuration 106 is performed using the application processor subsystem (APSS), and DPU frame processing 108 is performed by the DPU. As shown in FIG. 1, these steps can be pipelined, e.g., while the DPU processes one frame, the video core can prepare the next frame.

FIG. 1 illustrates a disadvantage of such a method – namely, that the APS must wake up at every new frame and configure the DPU appropriately. Repeatedly configuring the DPU 106 results in significant power consumption. On low-tier targets where it is not advisable to have a high quality of service (QoS) on central processing unit (CPU) cores to process threads and/or interrupts, frame processing can sometimes be delayed due to signaling delays, which can lead to video jitters or other artifacts.

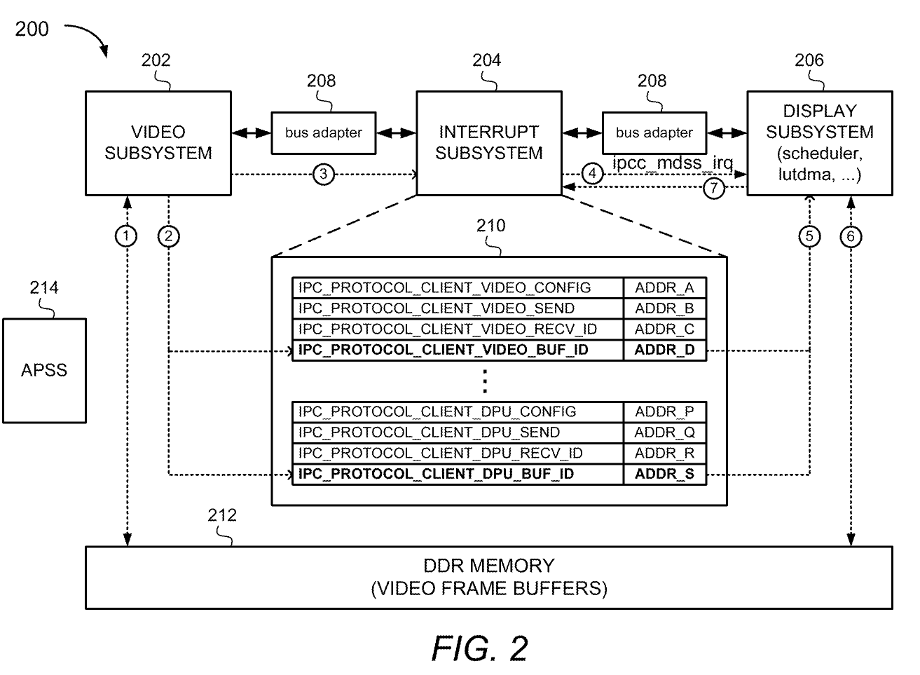

FIG. 2 is a block diagram illustrating a system 200 for processing video frames with reduced application processor system involvement, according to aspects of the disclosure. In the example illustrated in FIG. 2, system 200 includes a video subsystem 202 for preparing video frame data, an interrupt subsystem 204 (which may also be referred to as an interrupt processor communication controller, or IPCC) for handling interrupts, and a display subsystem 206 for processing and displaying video frame data that has been prepared by the video subsystem. In the example shown in FIG. 2, bus adapters 208 convert between bus protocols, e.g., such as the advanced extensible interface (AXI) bus protocol and the advanced high-performance bus (AHB) protocol, for example. In some aspects, bus adapters 208 are not needed. The interrupt subsystem 204 includes a set of configuration registers 210. In the example shown in FIG. 2, two additional control registers, IPC_Protocol_Client_Video_Buf_ID and IPC_Protocol_Client_DPU_Buf_ID, are used to identify a video frame buffer in dual-data-rate (DDR) memory 212. These two registers may be referred to herein as “the BUF_ID registers,” and either one of the registers may be referred to herein as “a BUF_ID register” or “one of the BUF_ID registers.”

In the example illustrated in FIG. 2, the interrupt subsystem 204 is responsible for communicating between hardware blocks without software intervention. The video subsystem 202 and the display subsystem 206 will use the interrupt subsystem 204 to communicate a hardware fence, i.e., when the video subsystem 202 has finished writing video frame data to a frame buffer within the memory 212, and when display subsystem 206 is finished consuming that frame data.

In the example illustrated in FIG. 2, the video subsystem 202 also communicates the identity of the video frame buffer (e.g., the buffer_ID) that it has just completed. As will be explained in more detail below, this enables frame skips or frame repeats when the video frame rate is not the same as the display frame rate. In addition, the buffer_ID allows the display subsystem 206 to retrieve configuration information specific to video frame data that is stored in a particular video frame buffer.

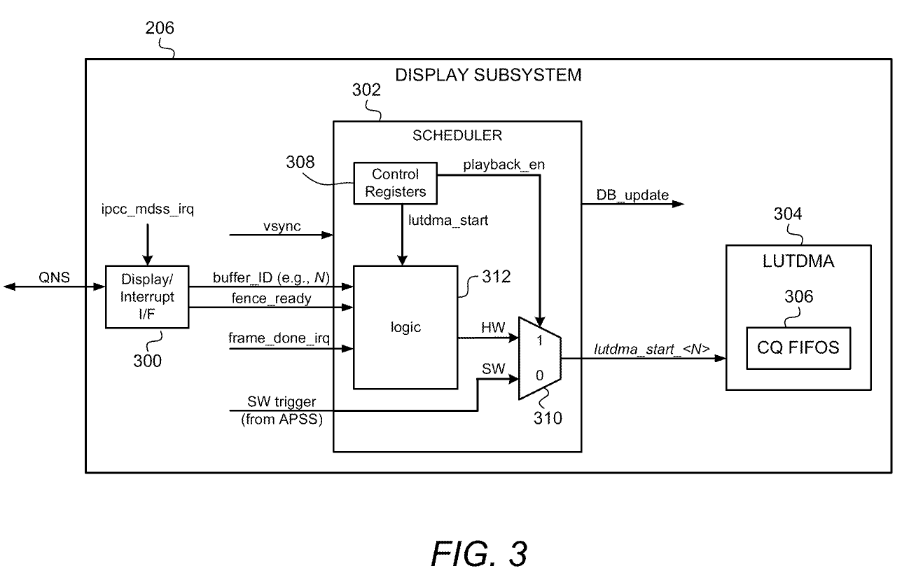

FIG. 2 also illustrates steps in a method for processing video frames according to aspects of the disclosure. When the video subsystem 202 has finished preparing a video frame (step 1), it communicates to the interrupt subsystem 204 that the video frame data is ready (step 2) and it writes to a BUF_ID register to tell which video frame buffer contains the completed video frame (step 3). The interrupt subsystem 204 generates an interrupt request, e.g., ipcc_mdss_irq, to the display subsystem 206 to indicate that a video frame buffer is ready (step 4). The display subsystem 206 reads the BUF_ID register to determine which video frame buffer is available (step 5), and then begins to configure itself to process the video frame data based on the video frame characteristics of that video frame. This will be shown in more detail in FIG. 3, below. The display subsystem 206 then processes the video frame data stored in the video frame buffer in DDR memory 212 identified by the BUF_ID register (step 6). Upon frame completion, the display subsystem 206 notifies the interrupt subsystem 204 that the current video frame is consumed and that the video frame buffer in DDR memory 212 can be released (step 7). As will be explained in more detail below, the configuration of the display subsystem 206 requires minimal involvement with an application processor subsystem (APSS) 214.

FIG. 3 is a block diagram illustrating an example display subsystem 206 in more detail according to aspects of the disclosure. In the example shown in FIG. 3, the display subsystem 206 includes an interface 300 between the display subsystem 206 and an interrupt subsystem 204, a scheduler 302, a look-up table (LUT) direct memory access (DMA) system (LUTDMA) 304, and a set of command queue (CQ) first-in-first-out (FIFO) buffers 306 within the LUTDMA 304. The LUTDMA 304The LUTDMA 304 is used to configure the display subsystem 206 to properly process a video frame, e.g., according to the video frame’s characteristics (size, resolution, color depth, etc.). The CQ FIFO buffers 306 hold those configuration commands.

In the example shown in FIG. 3, the scheduler 302 includes a set of control registers 308 for controlling the operation of the display subsystem 206. As shown in FIG. 3, a new control register bit “playback_en” controls a signal of the same name. The playback_en signal controls a selector 310 within the scheduler and a control signal “lutdma_start” triggers the LUTDMA to begin its operation. The selector 310 selects between a LUTDMA start signal generated by the display subsystem 206 (called the “hardware” signal) and a LUTDMA start signal generated by an APSS (called the “software” signal). In the example shown in FIG. 3, the output of the selector 310 is a LUTDMA start signal that indicates which video frame buffer (e.g., “N”) is to be processed, “lutdma_start_<N>.” This tells the LUTDMA 304 which command queue from which to pull configuration commands.

As shown in FIG. 3, when playback_en is inactive (e.g., set to logic 0), the lutdma_start_trigger is a legacy (software based) trigger, i.e., produced by an APSS, but when playback_en is active (e.g., set to logic 1), the lutdma_start_trigger is hardware based, i.e., produced without involvement of an APSS.

In the example shown in FIG. 3, a logic block 312 produces the hardware start signal based on inputs such as a fence_ready signal, which indicates that a video frame is ready to be processed by the display subsystem 206, a buffer_ID (e.g., a value “N”), which identifies the video frame buffer containing the video frame to be processed, and a frame_done_irq signal, which the display subsystem 206 generates when it has finished processing the previous video frame.

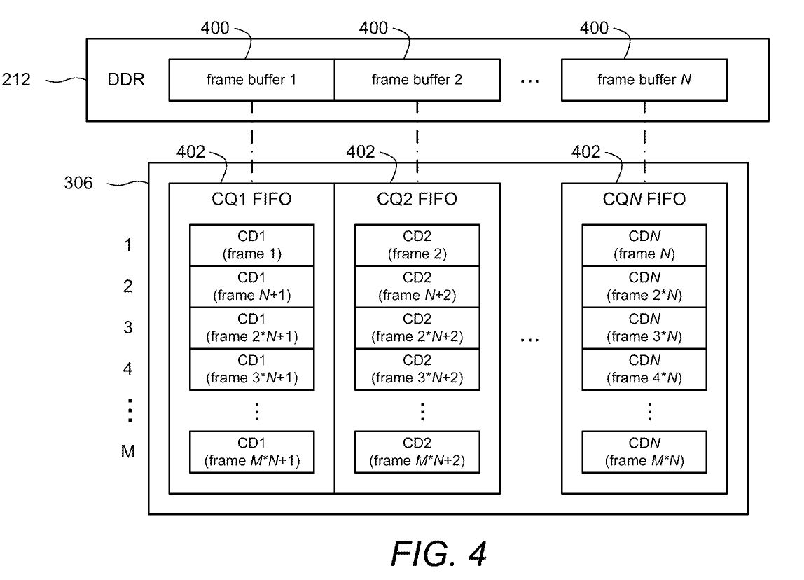

FIG. 4 is a diagram illustrating the relationship between video frame buffers and command queue FIFOs, according to aspects of the disclosure. In the example shown in FIG. 4, each video frame buffer 400 in DDR memory 212 has its own CQ FIFO 402, which is pre-loaded with commands needed to configure the display subsystem 206 according to the video frame characteristics of the video frame currently stored in that video frame buffer 400.

In the example shown in FIG. 4, the N frame buffers 400 are used in a round-robin order, e.g., frame buffer 1 is used for frame 1, frame N+1, frame 2*N+1, frame 3*N+1, etc.; frame buffer 2 is used for frame 2, frame 2*N+2, frame 3*N+2, etc.; and so on. In the example shown in FIG. 4, each video frame is associated with its own set of configuration commands.

In some aspects, a command packet (CP) contains information about what hardware block within the display subsystem 206 needs to be programmed and how that block’s register values should be set or modified. In some aspects, a CP may be stored in a known location in memory and the information contained there can be accessed as many times as needed. A command descriptor (CD) specifies a count of CPs and lists the addresses of each. Each command queue (CQ) holds one or more CDs, which point to one or more CPs.

FIG. 4 illustrates an embodiment in which a CD is popped from its CQ FIFO 402 and discarded after use. In the example shown in FIG. 4, each CQ FIFO 402 holds up to M CDs. Thus, the CQ FIFO buffers 306 can store configuration data for as many as N*M video frames before the CQ FIFO buffers 306 must be reloaded by a software process. However, if a video frame that was stored in a particular video frame buffer happens to have the same configuration requirements as the previous video frame stored in that same video frame buffer, there would be a benefit to reusing the CD.

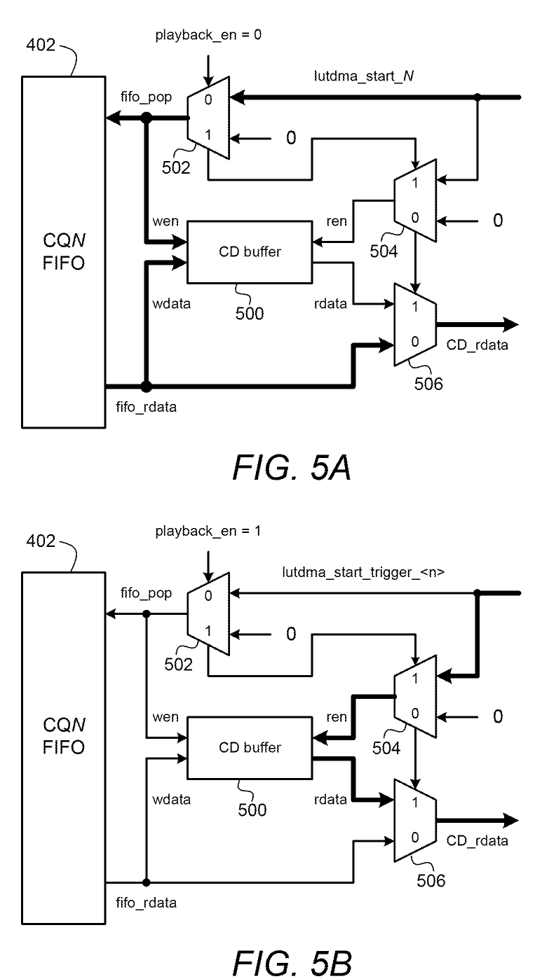

FIGS. 5A and 5B illustrate an embodiment in which a CD is not always discarded after one use, but is potentially reused again and again. In FIGS. 5A-5B, a CD buffer 500 stores a copy of the CD lasted popped from the CQ FIFO 402, and the signal playback_en controls a set of selectors – selector 502, selector 504, and selector 506 – that control data and signal flow within the circuit.

FIG. 5A shows the operation when playback_en is inactive (e.g., logic 0), during which the next CD is popped from the CQN FIFO 402 and stored in a CD buffer 500. In the example shown in FIG. 5A, The lutdma_start_N signal passes through selector 502 to operate both as the fifo_pop signal, which triggers the CQN FIFO 402 to pop the next CD, and as the wdata signal, which triggers the CD buffer 500 to store the CD that was popped from the CQN FIFO 402. The CD that was popped from the CQN FIFO 402 is also provided to the LUTDMA 304 as CD_rdata via the selector 506.

FIG. 5B shows the operation when playback_en is active (e.g., logic 1), during which the CD stored in the CD buffer 500 is reused rather than popping the next CD from the CQ FIFO 402. In the example shown in FIG. 5B, the lutdma_start_N signal is blocked by selector 502 from triggering a pop of the CQN FIFO 402 but instead routed through selector 504 to become the read signal for the CD buffer 500. The CD data stored within the CD buffer 500 is then provided to the LUTDMA 304 via the selector 506.

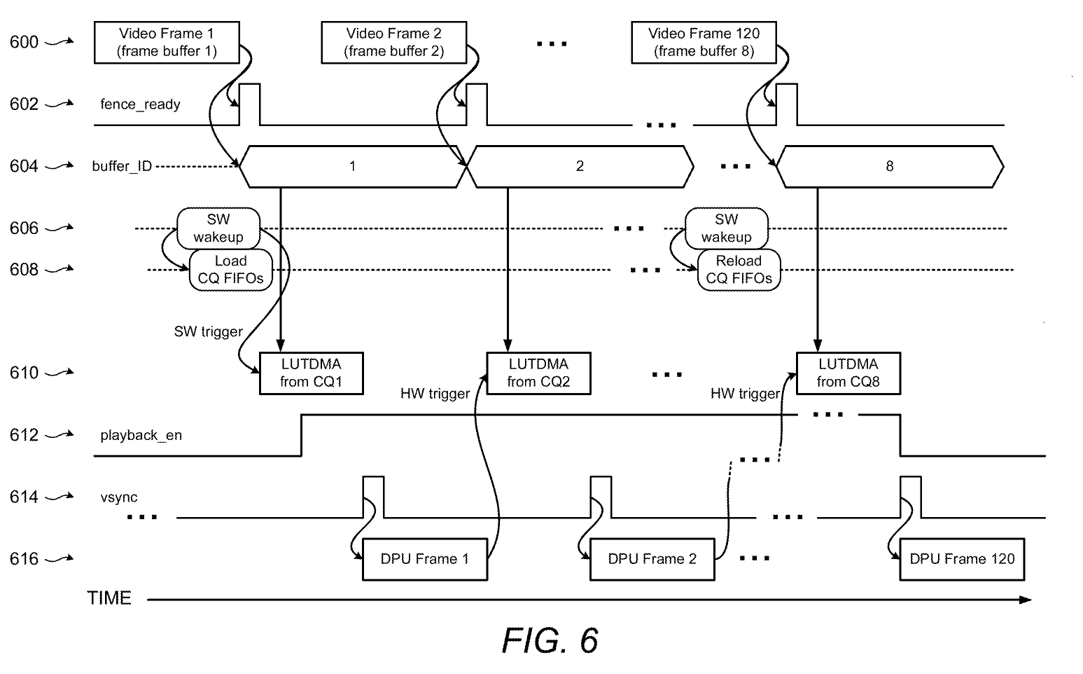

FIG. 6 is a diagram illustrating a method for processing video frames with reduced APSS involvement, according to aspects of the disclosure. In the example shown in FIG. 6, the video subsystem 202 prepares video frames that are stored in video frame buffers (row 600). When the video frame is ready the video subsystem 202 indicates this via the fence_ready signal (row 602) and identifies the video frame buffer by setting a buffer_ID register in the interrupt subsystem 204 (row 604). FIG. 6 illustrates an example in which eight video frame buffers are allocated in memory and used in a round-robin fashion, there are eight CQ FIFOs (one for each video frame buffer), each CQ FIFO can store eight CDs, and the video stream has one hundred and twenty video frames.

In the example shown in FIG. 6, while the video subsystem 202 is preparing the first video frame, the APSS wakes up (row 606) and loads the CQ FIFOs (row 608) with the configuration commands that the LUTDMA 304 will use to configure the display subsystem 206 to process particular video frames. In the example shown in FIG. 6, the APSS then sends a software trigger to start the LUTDMA 304. The LUTDMA 304 (row 610) then pops the top CD from the CQ FIFO associated with the video frame buffer identified by buffer_ID and executes CPs identified by the CD. This configures the display subsystem 206. In the example shown in FIG. 6, the playback_en signal (row 612) is then set to an active state.

In the example shown in FIG. 6, the vsync signal (row 614) triggers processing of a new DPU frame by the display subsystem 206 (row 616). If the playback_en signal is active, then once the DPU frame processing is completed, this triggers the LUTDMA to begin configuring the display subsystem 206 for processing the next DPU frame, e.g., by popping the top CD from the CQ FIFO associated with the next video frame buffer (again, identified by buffer ID) and executing the CPs identified by the CD.

This continues until the CQ FIFOs are empty. If more video frames remain to be processed, then in some aspects, the APSS wakes up again to reload the CQ FIFOs so that the pipelined process can continue until all video frames have been processed, at which time the playback_en signal is set to inactive state (e.g., logic 0). In the example used here, the CQ FIFOs will be empty after sixty four video frames have been processed, and so FIG. 6 shows a second software wakeup event for the purpose of reloading the CQ FIFOs for the remaining fifty six frames of the original one hundred and twenty video frames in the video stream.

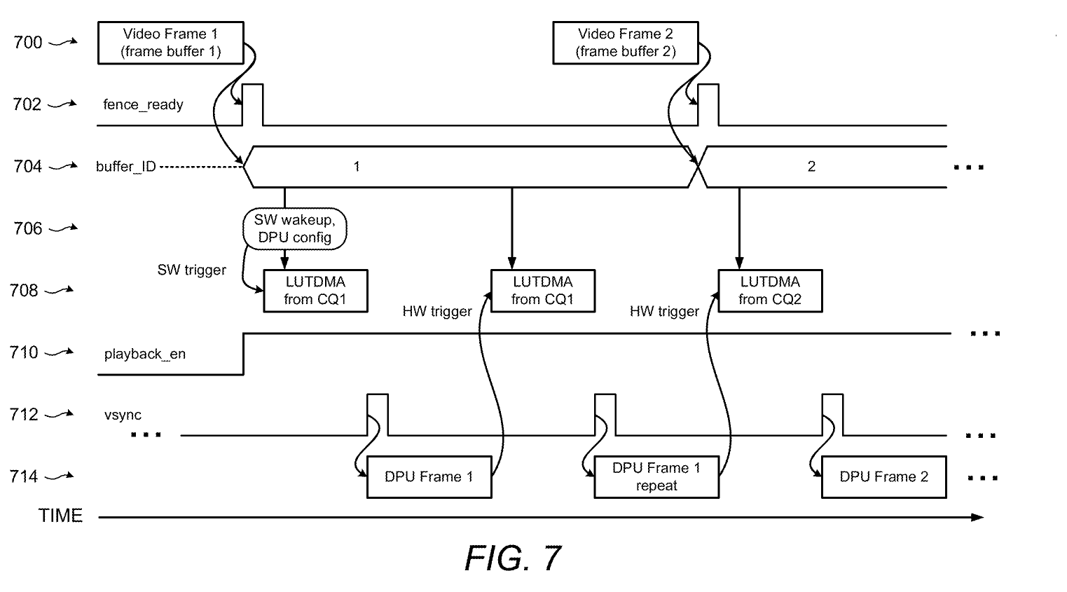

FIG. 7 is a diagram illustrating a method for processing video frames with reduced APSS involvement, according to aspects of the disclosure. FIG. 7 illustrates an example where the video frame rate is less than the display frame rate. In the example shown in FIG. 7, the video subsystem 202 prepares video frames that are stored in video frame buffers (row 700). When the video frame is ready the video subsystem 202 indicates this via the fence_ready signal (row 702) and identifies the video frame buffer by setting a buffer_ID register in the interrupt subsystem 204 (row 704). While the video subsystem 202 is preparing the first video frame, the APSS wakes up and loads the CQ FIFOs (row 706) with the configuration commands that the LUTDMA 304 will use to configure the display subsystem 206 to process particular video frames.

In the example shown in FIG. 7, the APSS then sends a software trigger to start the LUTDMA 304. The LUTDMA 304 (row 708) then pops the top CD from the CQ FIFO associated with the video frame buffer identified by buffer_ID and executes CPs identified by the CD. This configures the display subsystem 206. In the example shown in FIG. 7, the playback_en signal (row 710) is then set to an active state.

In the example shown in FIG. 7, the vsync signal (row 712) triggers processing of a new DPU frame by the display subsystem 206 (row 714). If the playback_en signal is active, then once the DPU frame processing is completed, this triggers the LUTDMA to begin configuring the display subsystem 206 for processing the next DPU frame, e.g., by popping the top CD from the CQ FIFO associated with the next video frame buffer (again, identified by buffer ID) and executing the CPs identified by the CD.

In the example shown in FIG. 7, the vsync signal (row 712) has a shorter period than the fence_ready signal (row 702). As a result, when the LUTDMA reads buffer_ID register, that register still points to the same video frame buffer as before, e.g., video frame buffer 1, so the same DPU frame is repeated. By the next occurrence of vsync, however, the video subsystem 204 has finished processing the second video frame and has updated the value in the buffer_ID register to identify the next video frame buffer to be used, e.g., video frame buffer 2. In this manner, video frames are repeated as needed to match the faster display frame rate.

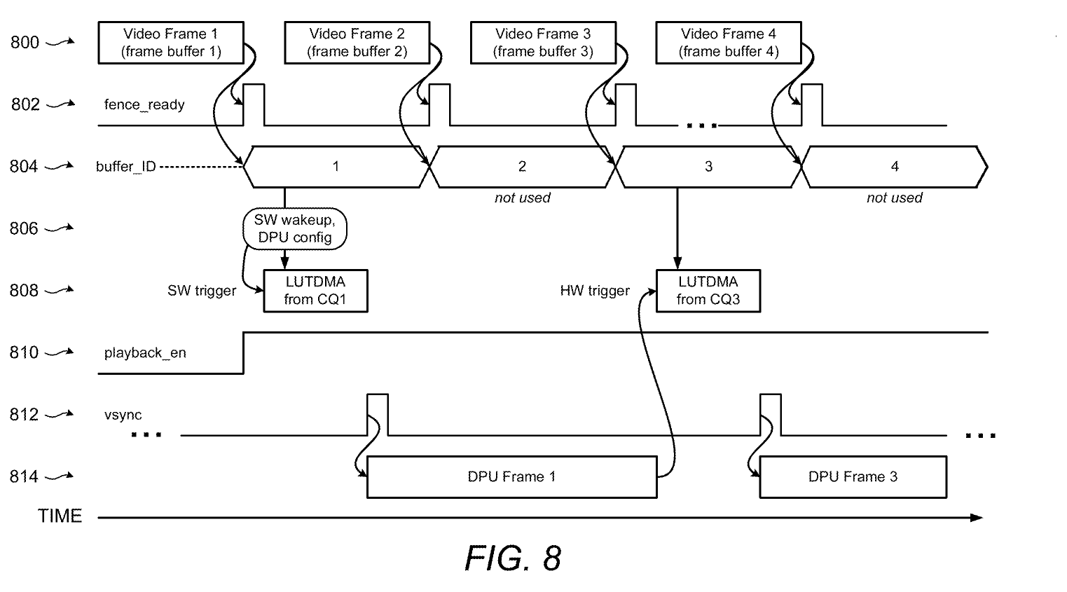

FIG. 8 is a diagram illustrating a method for processing video frames with reduced APSS involvement, according to aspects of the disclosure. FIG. 8 illustrates an example where the video frame rate is greater than the display frame rate. In the example shown in FIG. 8, the video subsystem 202 prepares video frames that are stored in video frame buffers (row 800). When the video frame is ready the video subsystem 202 indicates this via the fence_ready signal (row 802) and identifies the video frame buffer by setting a buffer_ID register in the interrupt subsystem 204 (row 804). While the video subsystem 202 is preparing the first video frame, the APSS wakes up and loads the CQ FIFOs (row 806) with the configuration commands that the LUTDMA 304 will use to configure the display subsystem 206 to process particular video frames.

In the example shown in FIG. 8, the APSS then sends a software trigger to start the LUTDMA 304. The LUTDMA 304 (row 808) then pops the top CD from the CQ FIFO associated with the video frame buffer identified by buffer_ID and executes CPs identified by the CD. This configures the display subsystem 206. In the example shown in FIG. 8, the playback_en signal (row 810) is then set to an active state.

In the example shown in FIG. 8, the vsync signal (row 812) triggers processing of a new DPU frame by the display subsystem 206 (row 814). If the playback_en signal is active, then once the DPU frame processing is completed, this triggers the LUTDMA to begin configuring the display subsystem 206 for processing the next DPU frame, e.g., by popping the top CD from the CQ FIFO associated with the next video frame buffer (again, identified by buffer ID) and executing the CPs identified by the CD.

In the example shown in FIG. 8, the vsync signal (row 812) has a longer period than the fence_ready signal (row 802). As a result, by the time that the LUTDMA reads buffer_ID register, that register has been updated twice: once to point to video frame buffer 2, and again to point to frame buffer 3. Thus, by the next occurrence of vsync, the video subsystem 204 has finished processing the third video frame and has updated the value in the buffer_ID register to identify the next video frame buffer to be used, e.g., video frame buffer 3. In this manner, video frames are skipped as needed to match the slower display frame rate.

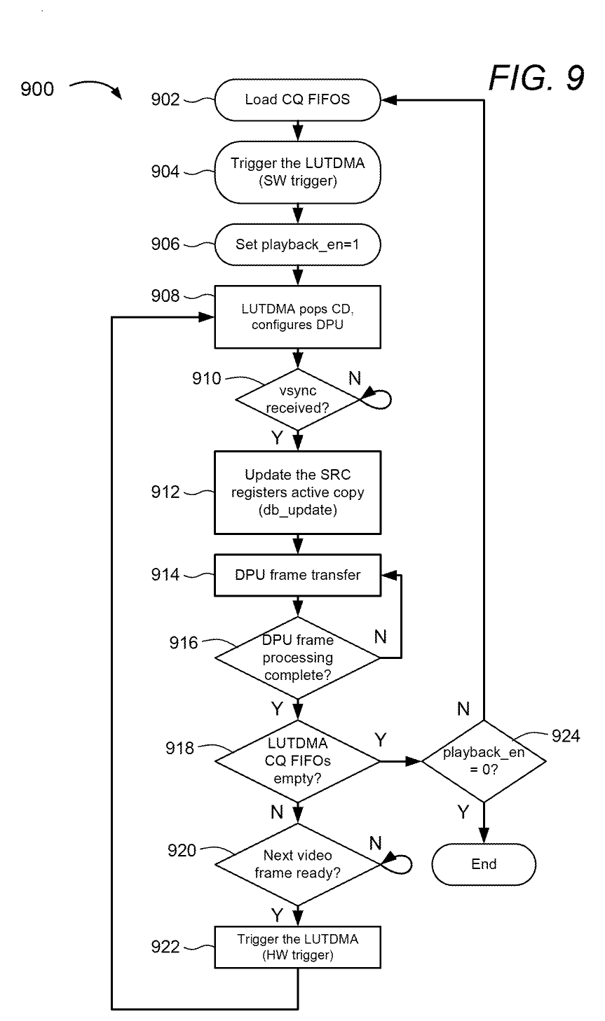

FIG. 9 is a flow chart illustrating a method 900 for processing video frames with reduced APSS involvement, according to aspects of the disclosure. In the example shown in FIG. 9, portions that are performed in hardware, e.g., by a video subsystem 202, an interrupt subsystem 204, a display subsystem 206, a memory 212, or combinations thereof, are shown as rectangles, while portions that are performed in software, e.g., by an APSS, are shown as rounded boxes. FIG. 9 illustrates an implementation which uses the display subsystem 206 and scheduler 302 as shown in FIG. 3, i.e., in which a CD is discarded after one use.

In the example shown in FIG. 9, the method 900 includes, at step 902, loading command packets (CPs) into command queue (CQ) FIFOs. In some aspects, this step may be performed by an APSS, and may include storing CPs at known locations in a memory, creating a command descriptor (CD) that contains a list of pointers to the desired CPs (e.g., the addresses of the desired CPs in memory), and pushing the CD onto a CQ FIFO. In some aspects, each CD configures the display subsystem 206 to process a specific video frame according to that video frame’s characteristics (e.g., size, resolution, color depth, etc.) In some aspects, this processes is repeated for each CQ. In some aspects, multiple CDs may be pushed into each CQ. In some aspects, each CQ is associated with a specific frame buffer in memory 212, and thus each CD is associated with a video frame that is stored in that specific frame buffer.

The method 900 further includes, at step 904, triggering the LUTDMA operation; this is a software trigger, which may be generated by an APSS. In some aspects, the APSS may trigger the LUTDMA operation by setting an interrupt flag within a control register of an interrupt subsystem 204. In some aspects, the APSS may trigger the LUTDMA operation by toggling an interrupt input signal into the interrupt subsystem 204. In some aspects, the APSS may trigger the LUTDMA operation by toggling a signal into the display subsystem 206.

The method 900 further includes, at step 906, setting the playback_en flag to an active value (e.g., logic 1). In some aspects, the APSS may do this by writing to a bit in a control register within the display subsystem 206.

The method 900 further includes, at step 908, popping a CD from the CQ FIFO associated with the frame buffer that contains the next frame to be processed by the display subsystem 206, and configuring the display subsystem 206 according to the configuration information contained within the CD. In some aspects, the next video frame buffer is identified by the BUF_ID register. This configuration of the display subsystem 206 is performed without any involvement or assistance from the APSS. In some aspects, this is performed by the LUTDMA. Upon completion of this step, the display subsystem 206 will be properly configured to process the video frame data contained within the next video frame buffer.

The method 900 further includes, at step 910, waiting for the vsync signal to be received. Upon detection of the vsync signal, the process moves to step 912. The method 900 further includes, at step 912, performing a double buffer (db) update, e.g., updating the source registers active copy. In some aspects, at least some of the SW registers in the DPU are double buffered, i.e., having both an active copy and a back copy. When the LUTDMA configures the DPU registers, it programs the back copy of these registers. Having a back copy allows the registers to be updated with values to be used for the next frame without accidentally overwriting the register values being used for the current frame. At vsync (which indicates a display frame boundary), the back copy gets pushed to the active copy. In some aspects, a db_update signal is generated for that purpose.

The method 900 further includes, at step 914, performing a DPU frame transfer, in which the DPU fetches the video frame data from the video frame buffer in DDR memory and pushes it to the display panel. This continues until DPU frame processing is complete, at which point the process moves to step 918. In some aspects, completion of DPU frame processing is signaled via a frame_done_irq signal.

The method 900 further includes, at step 918, the state of the LUTDMA CQ FIFOs is checked. If the LUTDMA CQ FIFOs are not empty, then the process moves to step 920, where the process waits until the next video frame is ready to be processed. In some aspects, a fence_ready signal is generated by the video subsystem 202 to indicate that the next video frame is ready to be processed by the display subsystem 206. In response to detecting that the next video frame is ready to be processed, the process moves to step 922.

The method 900 further includes, at step 922, triggering the LUTDMA operation; this is a hardware trigger, and is not generated by the APSS. In some aspects, this hardware trigger is generated by the display subsystem 206. In some aspects, the hardware trigger is based on fence_ready, frame_done_irq, and buffer_ID signals. In some aspects, the hardware trigger identifies or is associated with a specific video frame buffer. In response to the hardware trigger generated in step 922, the method 900 returns to step 908, in which the LUTDMA configures the display subsystem 206 to properly process the video frame stored in the video frame buffer identified by the buffer_ID.

In the example shown in FIG. 9, if, at step 918, the LUTDMA CQ FIFOs are empty, then the process moves to step 924, where the value of playback_en is considered. If playback_en = 0, then the video playback process is considered to be complete, and the method 900 ends. If playback_en = 1, however, this indicates that the LUTDMA CQ FIFOs need to be reloaded / refilled to process more video frames, and so the process returns to step 902 and continues from there.

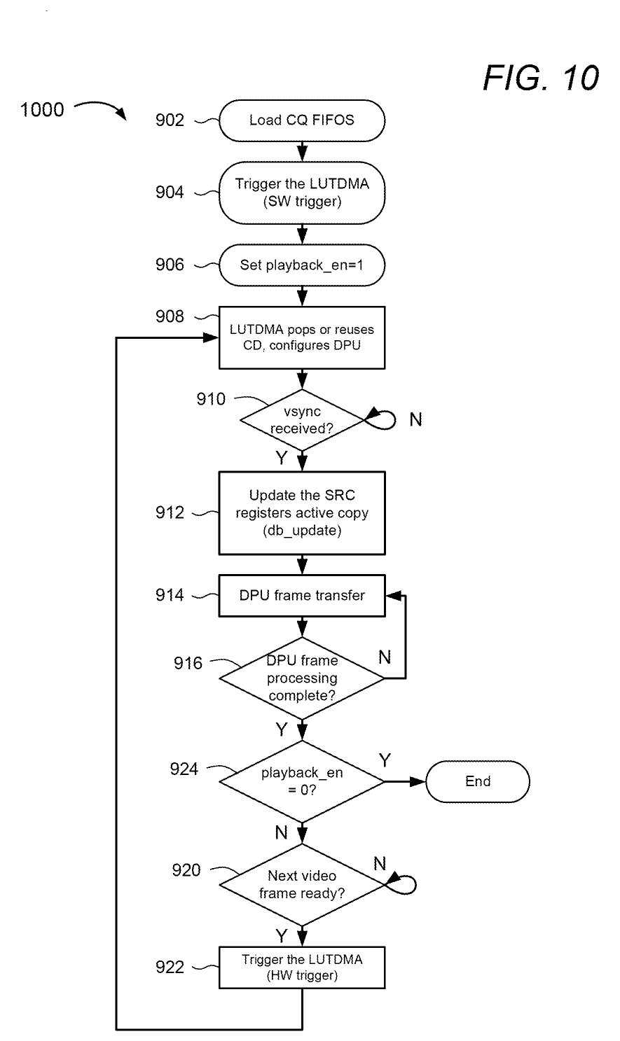

FIG. 10 is a flow chart illustrating a method 1000 for processing video frames with reduced APSS involvement, according to aspects of the disclosure. In the example shown in FIG. 10, portions that are performed in hardware, e.g., by a video subsystem 202, an interrupt subsystem 204, a display subsystem 206, a memory 212, or combinations thereof, are shown as rectangles, while portions that are performed in software, e.g., by an APSS, are shown as rounded boxes. FIG. 10 illustrates an implementation which uses the display subsystem 206 and circuitry as shown in FIGS. 5A and 5B, i.e., in which a CD may be reused rather than discarded after one use.

In FIG. 10, steps 902, 904, 906, 908, 910, 912, 914, 916, 920, 922, and 924 are similar to their like-numbered counterparts in FIG. 9, and therefore their descriptions will not be repeated here. The method shown in FIG. 10 is similar to the method shown in FIG. 9, with the exception that, because a CD may be reused instead of discarded after just one use, the method 1000 does not include a step to reload all of the CQ FIFOs, and in step 908, the LUTDMA may pop a new CD from the CQ FIFO 402 or may reuse a previous CD stored in the CD buffer 500. In some aspects, it may be presumed that once a CQ FIFO is empty the video processing task has completed. Thus, in FIG. 10, the process ends as soon as playback_en is set to an inactive state (e.g., logic 0).

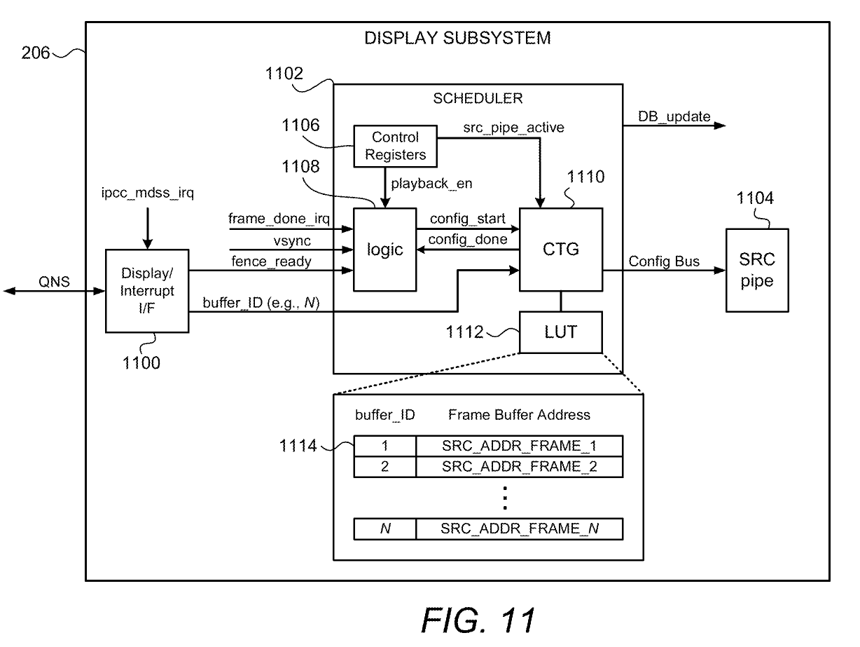

FIG. 11 is a block diagram illustrating an example display subsystem 206 in more detail according to other aspects of the disclosure. FIG. 11 illustrates an embodiment in which the source addresses of video frame buffers in memory 212 do not change. This allows the use of a source address lookup table within the display subsystem 206 corresponding to each buffer ID. The SRC LUT is programmed by software at the beginning of the video playback task.

In the example shown in FIG. 11, the display subsystem 206 includes an interface 1100 between the display subsystem 206 and an interrupt subsystem 204, a scheduler 1102, and a source pipe 1104. In the example shown in FIG. 11, the scheduler 1102 includes a set of control registers 1106 for controlling the operation of the display subsystem 206, a logic block 1108, a configuration transmission generator (CTG) 1110, and a source address lookup table (LUT) 1112. In the example shown in FIG. 11, the LUT 1112 includes one or more entries 1114. In the example illustrated in FIG. 11, each entry 1114 associates a buffer ID to a frame buffer address.

In the example shown in FIG. 11, during playback mode (e.g., playback_en=1) upon receiving a fence_ready signal and a frame_done_irq signal, the CTG 1110 configures the source address in the SRC pipe 1104 corresponding to the incoming buffer_ID. In this manner, the APSS can remain inactive during the playback task. Moreover, in this embodiment, there is no traffic to and from the memory 212 for fetching register information, which provides an additional power savings. The embodiment illustrated in FIG. 11 is for a single configuration update, but the same principles may be applied to use cases requiring multiple configuration updates, e.g., by the use of multiple LUTs 1112.

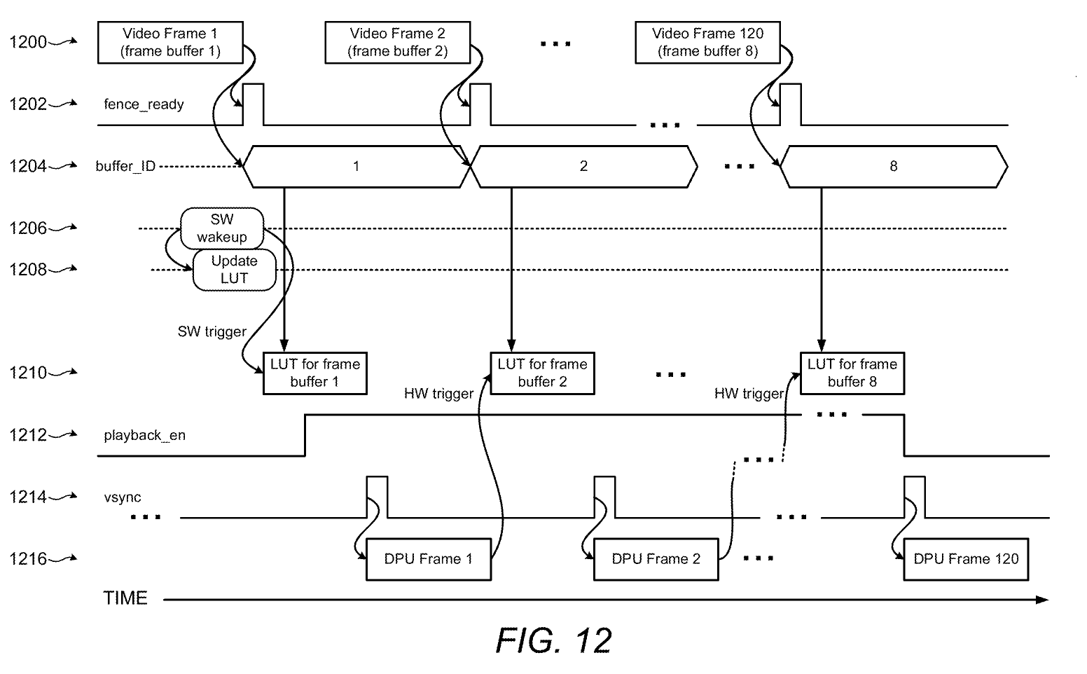

FIG. 12 is a diagram illustrating a method for processing video frames with reduced APSS involvement, according to aspects of the disclosure. In the example shown in FIG. 12, the video subsystem 202 prepares video frames that are stored in video frame buffers (row 1200). When the video frame is ready the video subsystem 202 indicates this via the fence_ready signal (row 1202) and identifies the video frame buffer by setting a buffer_ID register in the interrupt subsystem 204 (row 1204). FIG. 12 illustrates an example in which eight video frame buffers are allocated in memory and used in a round-robin fashion, there are eight CQ FIFOs (one for each video frame buffer), each CQ FIFO can store eight CDs, and the video stream has one hundred and twenty video frames.

In the example shown in FIG. 12, while the video subsystem 202 is preparing the first video frame, the APSS wakes up (row 1206) and updates the LUT (row 1208) with the configuration commands associated with each of the video frame buffers. In the example shown in FIG. 12, the APSS then sends a software trigger to start the LUT. The LUT executes the CDs pointed to by the LUT entry for the video frame buffer (row 1210). This configures the display subsystem 206. In the example shown in FIG. 12, the playback_en signal (row 1212) is then set to an active state.

In the example shown in FIG. 12, the vsync signal (row 1214) triggers processing of a new DPU frame by the display subsystem 206 (row 1216). If the playback_en signal is active, then once the DPU frame processing is completed, this triggers the LUT to begin configuring the display subsystem 206 for processing the next DPU frame, e.g., by executing the CDs pointed to by the LUT entry for the video frame buffer (again, identified by buffer ID). This process repeats until all video frames have been processed. This technique has the advantage that it reduces the number of times the display subsystem 206 needs to access the memory 212.

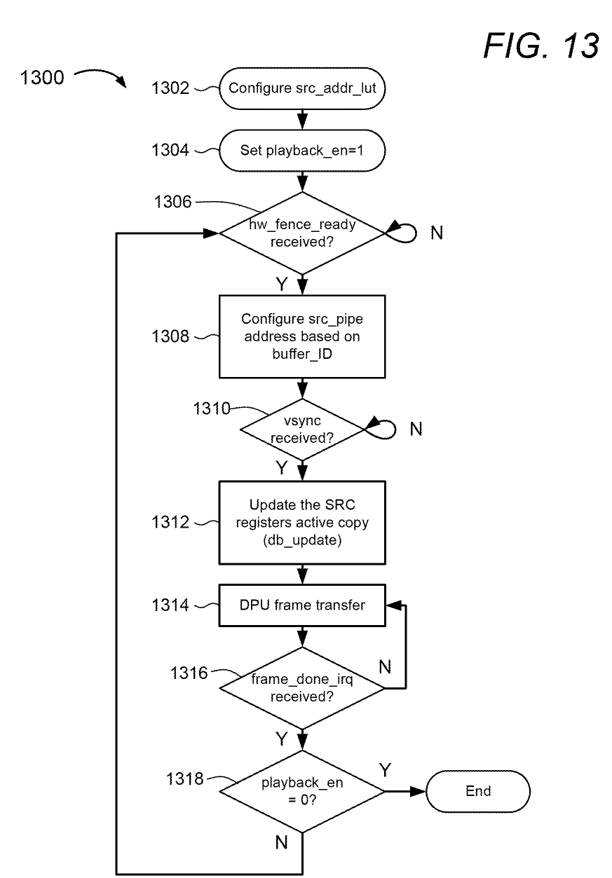

FIG. 13 is a flow chart illustrating a method 1300 for processing video frames with reduced APSS involvement, according to aspects of the disclosure. In the example shown in FIG. 13, portions that are performed in hardware, e.g., by a video subsystem 202, an interrupt subsystem 204, a display subsystem 206, a memory 212, or combinations thereof, are shown as rectangles, while portions that are performed in software, e.g., by an APSS, are shown as rounded boxes. FIG. 13 illustrates an implementation which uses the display subsystem 206 and scheduler 302 as shown in FIG. 11, i.e., in which a LUT and with internal memory is used rather than a LUTDMA and external memory 212.

In the example shown in FIG. 13, the method 1300 includes, at step 1302, configuring a LUT entries 1114 within the LUT 1112. In some aspects, this step may be performed by an APSS, and may include storing CPs at known locations in a memory, creating a command descriptor (CD) that contains a list of pointers to the desired CPs (e.g., the addresses of the desired CPs in memory), and updating the LUT entry 1114 with the location of that CD in the internal memory. In some aspects, each CD configures the display subsystem 206 to process a specific video frame according to that video frame’s characteristics (e.g., size, resolution, color depth, etc.) In some aspects, each LUT entry is associated with a specific frame buffer in memory 212, and thus each CD is associated with a video frame that is stored in that specific frame buffer.

The method 1300 further includes, at step 1304, setting the playback_en flag to an active value (e.g., logic 1). In some aspects, the APSS may do this by writing to a bit in a control register within the display subsystem 206.

The method 1300 further includes, at step 1306, waiting until the next video frame is ready to be processed. In some aspects, a fence_ready signal is generated by the video subsystem 202 to indicate that the next video frame is ready to be processed by the display subsystem 206. In response to detecting that the next video frame is ready to be processed, the process moves to step 1308.

The method 1300 further includes, at step 1308, configuring a SRC pipe address based on the buffer_ID. In some aspects, the LUT 1112 determines the buffer_ID of the next video frame to be processed by the display subsystem 206, uses the LUT table to determine the source address frame in memory, and pushes that address onto the SRC pipe 1104.

The method 1300 further includes, at step 1310, waiting for the vsync signal to be received. Upon detection of the vsync signal, the process moves to step 1312. The method 1300 further includes, at step 1312, performing a double buffer update, e.g., updating the source registers active copy with the values currently stored in the source registers back copy. The method 1300 further includes, at step 1314, performing a DPU frame transfer. This continues until DPU frame processing is complete, at which point the process moves to step 1316. In some aspects, completion of DPU frame processing is signaled via a frame_done_irq signal.

The method 1300 further includes, at step 1318, determining if playback_en is set to inactive state (e.g., logic 0). If so, the video playback task ends. If not, the method returns to step 1306 and waits for the next video frame to be made available to be processed by the display subsystem 206.

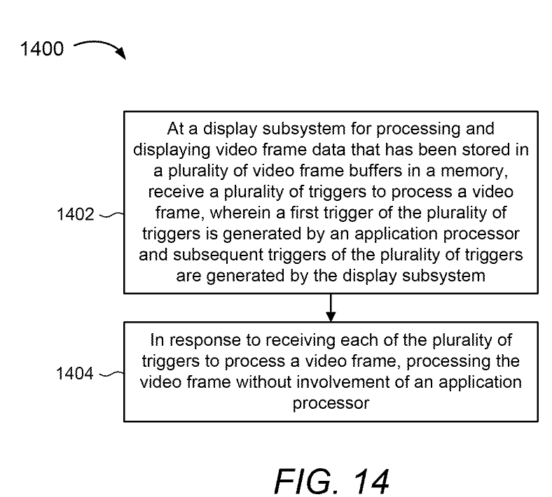

FIG. 14 is a flowchart of an example method 1400 for processing video frames with reduced application processor system involvement, according to aspects of the disclosure. In an aspect, portions of method 1400 may be performed by a video subsystem 202, an interrupt subsystem 204, a display subsystem 206, a memory 212, an application processor subsystem, or combinations thereof.

As shown in FIG. 14, method 1400 may include receiving, at a display subsystem for processing and displaying video frame data that has been stored in a plurality of video frame buffers in a memory, a plurality of triggers to process a video frame, wherein a first trigger of the plurality of triggers is generated by an application processor and subsequent triggers of the plurality of triggers are generated by the display subsystem (block 1402), and, in response to receiving each of the plurality of triggers, processing the video frame without involvement of an application processor (block 1404).

In some aspects, processing the video frame without involvement of the application processor comprises identifying a video frame buffer of the plurality of video frame buffers that contains the video frame to be processed, configuring the display subsystem for processing a video frame according to video frame characteristics of the video frame to be processed. processing the video frame to be processed, and sending the processed video frame to a display unit.

In some aspects, the video frame characteristics of the video frame to be processed comprise at least one of a video frame height, a video frame width, a video frame pixel depth, a video frame rate, or a video frame data format.

In some aspects, the method 1400 further comprises releasing the video frame buffer for use to store another video frame.

In some aspects, identifying the video frame buffer that contains the video frame to be processed comprises reading a video frame buffer identification register within an interrupt subsystem separate from the display subsystem.

In some aspects, configuring the display subsystem for processing a video frame according to the video frame characteristics of the video frame to be processed comprises receiving a set of one or more configuration commands for configuring an operation of the display subsystem.

In some aspects, configuring the display subsystem for processing a video frame according to the video frame characteristics of the video frame to be processed comprises using look-up table (LUT) direct memory access (DMA) to read the set of one or more configuration commands, which have been stored into the memory.

In some aspects, configuring the display subsystem for processing a video frame according to the video frame characteristics of the video frame to be processed comprises using a look-up table (LUT) to read the set of one or more configuration commands, which have been stored within the display subsystem.

In some aspects, receiving the set of one or more configuration commands for configuring the operation of the display subsystem comprises receiving the set of one or more configuration commands from a command queue (CQ) that is associated with the video frame buffer that contains the video frame to be processed.

In some aspects, the plurality of video frame buffers comprises N number of video frame buffers and wherein each of the N video frame buffers is associated with a respective one of a plurality of command queues, wherein each command queue in the plurality of command queues stores M number of command descriptors, and wherein each command descriptor comprises one or more configuration commands for a video frame.

In some aspects, each command descriptor is removed from its respective command queue after being used to process the video frame and wherein involvement of the application processor is required to reload the plurality of command queues after N x M video frames have been processed.

In some aspects, a command descriptor is not removed from its respective command queue when it can be reused for a next video frame and is removed from its respective command queue when it cannot be reused for a next video frame.

In some aspects, receiving the plurality of triggers to process a video frame comprises receiving a first trigger for processing a video frame, processing a video frame N, and receiving a second trigger for processing a video frame.

In some aspects, the method 1400 further comprises determining that the video frame N+1 is ready for processing, and processing video frame N+1, determining that video frame N+1 is not ready for processing, and resending the processed video frame N to a display unit or reprocessing the video frame N, or determining that video frame N+2 is ready for processing, and processing video frame N+2 instead of video frame N+1.

Method 1400 may include additional implementations, such as any single implementation or any combination of implementations described below and/or in connection with one or more other methods described elsewhere herein. Although FIG. 14 shows example blocks of method 1400, in some implementations, method 1400 may include additional blocks, fewer blocks, different blocks, or differently arranged blocks than those depicted in FIG. 14. Additionally, or alternatively, two or more of the blocks of method 1400 may be performed in parallel.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method for processing video frames with reduced application processor involvement, the method comprising: at a display subsystem for processing and displaying video frame data that has been stored in a plurality of video frame buffers in a memory: receiving a plurality of triggers to process a video frame; and in response to receiving each of the plurality of triggers, processing the video frame without involvement of an application processor, wherein a first trigger of the plurality of triggers is generated by the application processor and subsequent triggers of the plurality of triggers are generated by the display subsystem.

Clause 2. The method of clause 1, wherein processing the video frame without involvement of the application processor comprises: identifying a video frame buffer of the plurality of video frame buffers that contains the video frame to be processed; configuring the display subsystem for processing a video frame according to video frame characteristics of the video frame to be processed; processing the video frame to be processed; and sending the processed video frame to a display unit.

Clause 3. The method of clause 2, wherein the video frame characteristics of the video frame to be processed comprise at least one of a video frame height, a video frame width, a video frame pixel depth, a video frame rate, or a video frame data format.

Clause 4. The method of any of clauses 2 to 3, further comprising releasing the video frame buffer for use to store another video frame.

Clause 5. The method of any of clauses 2 to 4, wherein identifying the video frame buffer that contains the video frame to be processed comprises reading a video frame buffer identification register within an interrupt subsystem separate from the display subsystem.

Clause 6. The method of any of clauses 2 to 5, wherein configuring the display subsystem for processing a video frame according to the video frame characteristics of the video frame to be processed comprises receiving a set of one or more configuration commands for configuring an operation of the display subsystem.

Clause 7. The method of clause 6, wherein configuring the display subsystem for processing a video frame according to the video frame characteristics of the video frame to be processed comprises using look-up table (LUT) direct memory access (DMA) to read the set of one or more configuration commands, which have been stored into the memory.

Clause 8. The method of any of clauses 6 to 7, wherein configuring the display subsystem for processing a video frame according to the video frame characteristics of the video frame to be processed comprises using a look-up table (LUT) to read the set of one or more configuration commands, which have been stored within the display subsystem.

Clause 9. The method of any of clauses 7 to 8, wherein receiving the set of one or more configuration commands for configuring the operation of the display subsystem comprises receiving the set of one or more configuration commands from a command queue (CQ) that is associated with the video frame buffer that contains the video frame to be processed.

Clause 10. The method of clause 9, wherein the plurality of video frame buffers comprises N number of video frame buffers and wherein each of the N video frame buffers is associated with a respective one of a plurality of command queues, wherein each command queue in the plurality of command queues stores M number of command descriptors, and wherein each command descriptor comprises one or more configuration commands for a video frame.

Clause 11. The method of clause 10, wherein each command descriptor is removed from its respective command queue after being used to process the video frame and wherein involvement of the application processor is required to reload the plurality of command queues after N x M video frames have been processed.

Clause 12. The method of any of clauses 10 to 11, wherein a command descriptor is not removed from its respective command queue when it can be reused for a next video frame and is removed from its respective command queue when it cannot be reused for a next video frame.

Clause 13. The method of any of clauses 1 to 12, wherein receiving the plurality of triggers to process a video frame comprises: receiving a first trigger for processing a video frame; processing a video frame N; and receiving a second trigger for processing a video frame.

Clause 14. The method of clause 13, further comprising: determining that the video frame N+1 is ready for processing, and processing video frame N+1; determining that video frame N+1 is not ready for processing, and resending the processed video frame N to a display unit or reprocessing the video frame N; or determining that video frame N+2 is ready for processing, and processing video frame N+2 instead of video frame N+1.

Clause 15. A semiconductor device, comprising: an application processor subsystem comprising one or more processors for executing application software; an interrupt subsystem for handing interrupts; a video subsystem for preparing video frame data and storing it in a plurality of video frame buffers in a memory; and a display subsystem for processing and displaying video frame data that has been stored in the plurality of video frame buffers, wherein the display subsystem is configured to: receive a plurality of triggers to process a video frame; and in response to receiving each of the plurality of triggers, process the video frame without involvement of the application processor subsystem, wherein a first trigger of the plurality of triggers is generated by the application processor subsystem sent to the display subsystem via the interrupt subsystem, and subsequent triggers of the plurality of triggers are generated internally by the display subsystem.

Clause 16. The semiconductor device of clause 15, wherein, to process the video frame without involvement of the application processor subsystem, the display subsystem is configured to: identify a video frame buffer of the plurality of video frame buffers that contains the video frame to be processed; configure itself for processing a video frame according to video frame characteristics of the video frame to be processed; process the video frame to be processed; and send the processed video frame to a display unit.

Clause 17. The semiconductor device of clause 16, wherein the video frame characteristics of the video frame to be processed comprise at least one of a video frame height, a video frame width, a video frame pixel depth, a video frame rate, or a video frame data format.

Clause 18. The semiconductor device of any of clauses 16 to 17, wherein the display subsystem is further configured to release the video frame buffer for use to store another video frame.

Clause 19. The semiconductor device of any of clauses 16 to 18, wherein, to identify the video frame buffer that contains the video frame to be processed, the display subsystem is configured to read a video frame buffer identification register within the interrupt subsystem.

Clause 20. The semiconductor device of any of clauses 16 to 19, wherein, to configure itself for processing a video frame according to the video frame characteristics of the video frame to be processed, the display subsystem is configured to receive a set of one or more configuration commands for configuring an operation of the display subsystem.

Clause 21. The semiconductor device of clause 20, wherein, to configure itself for processing a video frame according to the video frame characteristics of the video frame to be processed, the display subsystem is configured to use look-up table (LUT) direct memory access (DMA) to read the set of one or more configuration commands, which have been stored into the memory.

Clause 22. The semiconductor device of any of clauses 20 to 21, wherein, to configure itself for processing a video frame according to the video frame characteristics of the video frame to be processed, the display subsystem is configured to use look-up table (LUT) to read the set of one or more configuration commands, which have been stored within the display subsystem.

Clause 23. The semiconductor device of any of clauses 21 to 22, wherein, to receive the set of one or more configuration commands for configuring the operation of the display subsystem, the display subsystem is configured to receive the set of one or more configuration commands from a command queue (CQ) that is associated with the video frame buffer that contains the video frame to be processed.

Clause 24. The semiconductor device of clause 23, wherein the plurality of video frame buffers comprises N number of video frame buffers and wherein each of the N video frame buffers is associated with a respective one of a plurality of command queues, wherein each command queue in the plurality of command queues stores M number of command descriptors, and wherein each command descriptor comprises one or more configuration commands for a video frame.

Clause 25. The semiconductor device of clause 24, wherein each command descriptor is removed from its respective command queue after being used to process the video frame and wherein involvement of the application processor is required to reload the plurality of command queues after N x M video frames have been processed.

Clause 26. The semiconductor device of any of clauses 24 to 25, wherein a command descriptor is not removed from its respective command queue when it can be reused for a next video frame and is removed from its respective command queue when it cannot be reused for a next video frame.

Clause 27. The semiconductor device of any of clauses 15 to 26, wherein, to receive the plurality of triggers to process a video frame, the display subsystem is configured to: receive a first trigger for processing a video frame; process a video frame N; and receive a second trigger for processing a video frame.

Clause 28. The semiconductor device of clause 27, wherein the display subsystem is further configured to: determine that the video frame N+1 is ready for processing, and process video frame N+1; determine that video frame N+1 is not ready for processing, and resend the processed video frame N to a display unit or reprocess the video frame N; or determine that video frame N+2 is ready for processing, and process video frame N+2 instead of video frame N+1.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method for processing video frames with reduced application processor involvement, the method comprising:
at a display subsystem for processing and displaying video frame data that has been stored in a plurality of video frame buffers in a memory:
receiving a plurality of triggers to process a video frame; and
in response to receiving each of the plurality of triggers, processing the video frame without involvement of an application processor,
wherein a first trigger of the plurality of triggers is generated by the application processor and subsequent triggers of the plurality of triggers are generated by the display subsystem.

2. The method of claim 1, wherein processing the video frame without involvement of the application processor comprises:
identifying a video frame buffer of the plurality of video frame buffers that contains the video frame to be processed;
configuring the display subsystem for processing a video frame according to video frame characteristics of the video frame to be processed;
processing the video frame to be processed; and
sending the processed video frame to a display unit.

3. The method of claim 2, wherein the video frame characteristics of the video frame to be processed comprise at least one of a video frame height, a video frame width, a video frame pixel depth, a video frame rate, or a video frame data format.

4. The method of claim 2, further comprising releasing the video frame buffer for use to store another video frame.

5. The method of claim 2, wherein identifying the video frame buffer that contains the video frame to be processed comprises reading a video frame buffer identification register within an interrupt subsystem separate from the display subsystem.

6. The method of claim 2, wherein configuring the display subsystem for processing a video frame according to the video frame characteristics of the video frame to be processed comprises receiving a set of one or more configuration commands for configuring an operation of the display subsystem.

7. The method of claim 6, wherein configuring the display subsystem for processing a video frame according to the video frame characteristics of the video frame to be processed comprises using look-up table (LUT) direct memory access (DMA) to read the set of one or more configuration commands, which have been stored into the memory.

8. The method of claim 6, wherein configuring the display subsystem for processing a video frame according to the video frame characteristics of the video frame to be processed comprises using a look-up table (LUT) to read the set of one or more configuration commands, which have been stored within the display subsystem.

9. The method of claim 7, wherein receiving the set of one or more configuration commands for configuring the operation of the display subsystem comprises receiving the set of one or more configuration commands from a command queue (CQ) that is associated with the video frame buffer that contains the video frame to be processed.

10. The method of claim 9, wherein the plurality of video frame buffers comprises N number of video frame buffers and wherein each of the N video frame buffers is associated with a respective one of a plurality of command queues, wherein each command queue in the plurality of command queues stores M number of command descriptors, and wherein each command descriptor comprises one or more configuration commands for a video frame.

11. The method of claim 10, wherein each command descriptor is removed from its respective command queue after being used to process the video frame and wherein involvement of the application processor is required to reload the plurality of command queues after N x M video frames have been processed.

12. The method of claim 10, wherein a command descriptor is not removed from its respective command queue when it can be reused for a next video frame and is removed from its respective command queue when it cannot be reused for a next video frame.

13. The method of claim 1, wherein receiving the plurality of triggers to process a video frame comprises:
receiving a first trigger for processing a video frame;
processing a video frame N; and
receiving a second trigger for processing a video frame.

14. The method of claim 13, further comprising:
determining that the video frame N+1 is ready for processing, and processing video frame N+1;
determining that video frame N+1 is not ready for processing, and resending the processed video frame N to a display unit or reprocessing the video frame N; or
determining that video frame N+2 is ready for processing, and processing video frame N+2 instead of video frame N+1.

15. A semiconductor device, comprising:
an application processor subsystem comprising one or more processors for executing application software;
an interrupt subsystem for handing interrupts;
a video subsystem for preparing video frame data and storing it in a plurality of video frame buffers in a memory; and
a display subsystem for processing and displaying video frame data that has been stored in the plurality of video frame buffers,
wherein the display subsystem is configured to:
receive a plurality of triggers to process a video frame; and
in response to receiving each of the plurality of triggers, process the video frame without involvement of the application processor subsystem,
wherein a first trigger of the plurality of triggers is generated by the application processor subsystem sent to the display subsystem via the interrupt subsystem, and subsequent triggers of the plurality of triggers are generated internally by the display subsystem.

16. The semiconductor device of claim 15, wherein, to process the video frame without involvement of the application processor subsystem, the display subsystem is configured to:
identify a video frame buffer of the plurality of video frame buffers that contains the video frame to be processed;
configure itself for processing a video frame according to video frame characteristics of the video frame to be processed;
process the video frame to be processed; and
send the processed video frame to a display unit.

17. The semiconductor device of claim 16, wherein, to identify the video frame buffer that contains the video frame to be processed, the display subsystem is configured to read a video frame buffer identification register within the interrupt subsystem.

18. The semiconductor device of claim 16, wherein, to configure itself for processing a video frame according to the video frame characteristics of the video frame to be processed, the display subsystem is configured to receive a set of one or more configuration commands for configuring an operation of the display subsystem, by using a look-up table (LUT) direct memory access (DMA) to read the set of one or more configuration commands, which have been stored into the memory, or by using a LUT to read the set of one or more configuration commands, which have been stored within the display subsystem.

19. The semiconductor device of claim 18, wherein, to receive the set of one or more configuration commands for configuring the operation of the display subsystem, the display subsystem is configured to receive the set of one or more configuration commands from a command queue (CQ) that is associated with the video frame buffer that contains the video frame to be processed.

20. The semiconductor device of claim 15, wherein, to receive the plurality of triggers to process a video frame, the display subsystem is configured to:
receive a first trigger for processing a video frame;
process a video frame N;
receive a second trigger for processing a video frame; and:
determine that the video frame N+1 is ready for processing, and process video frame N+1;
determine that video frame N+1 is not ready for processing, and resend the processed video frame N to a display unit or reprocess the video frame N; or
determine that video frame N+2 is ready for processing, and process video frame N+2 instead of video frame N+1.
